(19) United States
(12) Patent Application Publication
(10) Pub. No.: US 2023/0354778 A1
(43) Pub. Date: Nov. 9, 2023

(54) ANIMAL GROOMING WAGON

(71) Applicant: Ramiro M. Martinez, Aurora, IL (US)

(72) Inventor: Ramiro M. Martinez, Aurora, IL (US)

(21) Appl. No.: 17/737,175

(22) Filed: May 5, 2022

(51) Int. Cl. A01K 15/04; A01K 13/00; B62B 3/00; B62B 3/02; B62B 5/04; B62B 3/04

(52) U.S. Cl. CPC A01K 15/04; A01K 13/00; B62B 3/002; B62B 3/02; B62B 5/0414; B62B 3/001; B62B 3/04; B62B 2202/42; B62B 2205/006

(57) ABSTRACT

Animal grooming wagons are presented including: a base having a substantially planar top surface and forming a rectangular shape, where the base includes: a pair of end wall receiving slots each positioned along opposite end portions of the base; a pair of side wall receiving slots each positioned along opposite side portions of the base; removable inserts positioned along the top surface of the base; a front steerable wheeled axle positioned along the front-end portion of the base; a rear wheeled axle positioned along the rear-end portion of the base; a steering bar for steering the front steerable wheeled axle; and an anchor point positioned centrally along the top surface of the base.

### BACKGROUND

Animals each have distinct personalities and habits. While some animals are calm or docile, others are aggressive or excitable. Grooming carries with it special considerations. Often, for example, a pet will hide from an owner when a wash basin is being prepared. In other examples, a pet will run away during bathing or refuse to sit still for nail clipping or fur trimming. In these examples, owners are often frustrated which can compound the anxiety for the animal. Conventional solutions include professional grooming tables that hold and secure an animal in a semi-fixed position during grooming. These tables are typically waist high and can occasionally lead to injury when the animal attempts to escape the grooming. In other examples, an animal may need to be transported to a washing station but resists by excessing pulling on the leash. All of these issues contribute to a poor experience both for the owner/groomer and the animal.

As such animal grooming wagons are presented herein.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

As such, animal grooming wagons are presented including: a base having a substantially planar top surface and forming a rectangular shape, where the base includes: a pair of end wall receiving slots each positioned along opposite end portions of the base; a pair of side wall receiving slots each positioned along opposite side portions of the base; removable inserts positioned along the top surface of the base; a front steerable wheeled axle positioned along the front-end portion of the base; a rear wheeled axle positioned along the rear-end portion of the base; a steering bar for steering the front steerable wheeled axle; and an anchor point positioned centrally along the top surface of the base; a first removable end wall having a first tab along a first bottom edge and sized to either of the pair of end wall receiving slots; a second removable end wall having a second tab along a second bottom edge and sized to either of the pair of end wall receiving slots; a first removable side wall having a third tab along a third bottom edge and sized to either of the pair of side wall receiving slots; and a second removable side wall having a third tab along a third bottom edge and sized to either of the pair of side wall receiving slots. In some embodiments, the steerable front wheeled axle further includes: a braking mechanism. In some embodiments, the braking mechanism is actuated by the steering bar, where when the steering bar is released, the braking mechanism is engaged, and where when the steering bar is elevated, the braking mechanism is released. In some embodiments, the rear steerable wheeled axle further includes: a cable actuated braking mechanism. In some embodiments, the plurality of removable inserts includes drain grates having a slot width of less than approximately 0.5 inches. In some embodiments, the anchor point further includes an adjustable anchor strap.

In other embodiments, animal grooming systems are presented including: an animal grooming wagon including: a base having a substantially planar top surface and forming a rectangular shape, where the base includes: a pair of end wall receiving slots each positioned along opposite end portions of the base; a pair of side wall receiving slots each positioned along opposite side portions of the base; removable inserts positioned along the top surface of the base; a steerable front wheeled axle positioned along the front-end portion of the base; a rear wheeled axle positioned along the rear-end portion of the base; a steering bar for steering the front steerable wheeled axle; and an anchor point positioned centrally along the top surface of the base; a first removable end wall having a first tab along a first bottom edge and sized to either of the pair of end wall receiving slots; a second removable end wall having a second tab along a second bottom edge and sized to either of the pair of end wall receiving slots; a first removable side wall having a third tab along a third bottom edge and sized to either of the pair of side wall receiving slots; and a second removable side wall having a third tab along a third bottom edge and sized to either of the pair of side wall receiving slots; an adjustable anchor strap; and an adjustable animal harness.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustrative sideview representation of an animal grooming wagon in accordance with embodiments of the present invention;

FIG. 2 is an illustrative sideview representation of an animal grooming wagon in accordance with embodiments of the present invention;

FIG. 3 is an illustrative front-view representation of an animal grooming wagon in accordance with embodiments of the present invention;

FIG. 4 is an illustrative rear-view representation of an animal grooming wagon in accordance with embodiments of the present invention;

FIG. 5 is an illustrative top-view representation of an animal grooming wagon in accordance with embodiments of the present invention;

FIG. 6 is an illustrative sideview representation of an animal grooming wagon in use in accordance with embodiments of the present invention; and

FIG. 7 is an illustrative sideview representation of an animal grooming wagon in use in accordance with embodiments of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

In still other instances, specific numeric references such as “first material,” may be made. However, the specific numeric reference should not be interpreted as a literal sequential order but rather interpreted that the “first material” is different than a “second material.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

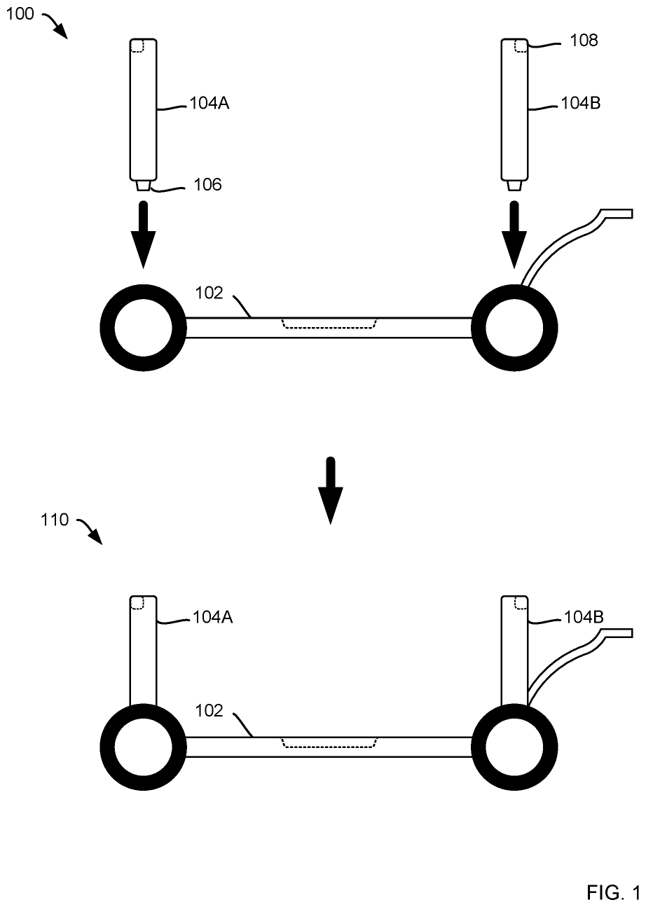

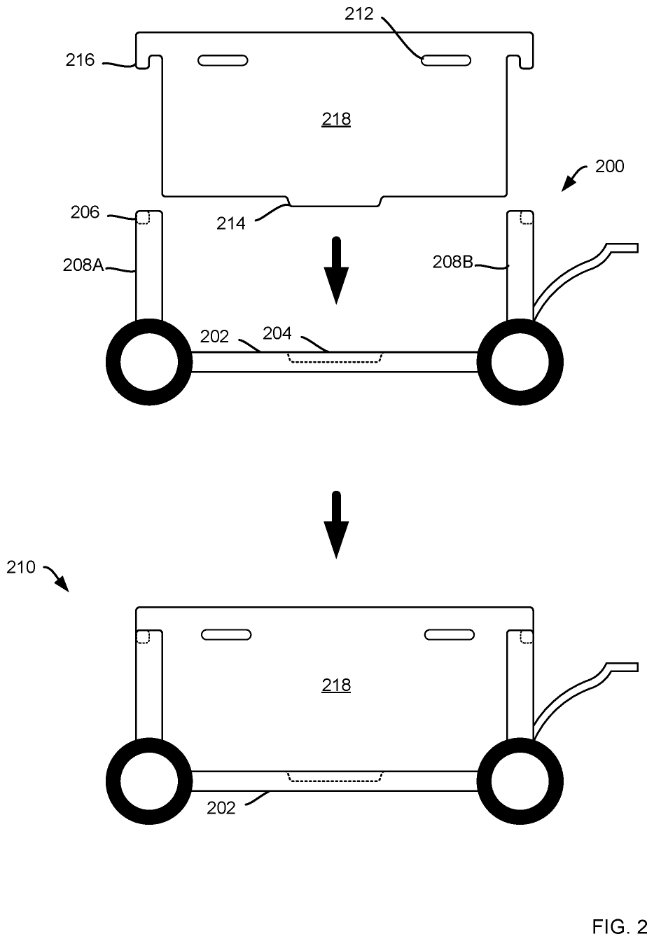

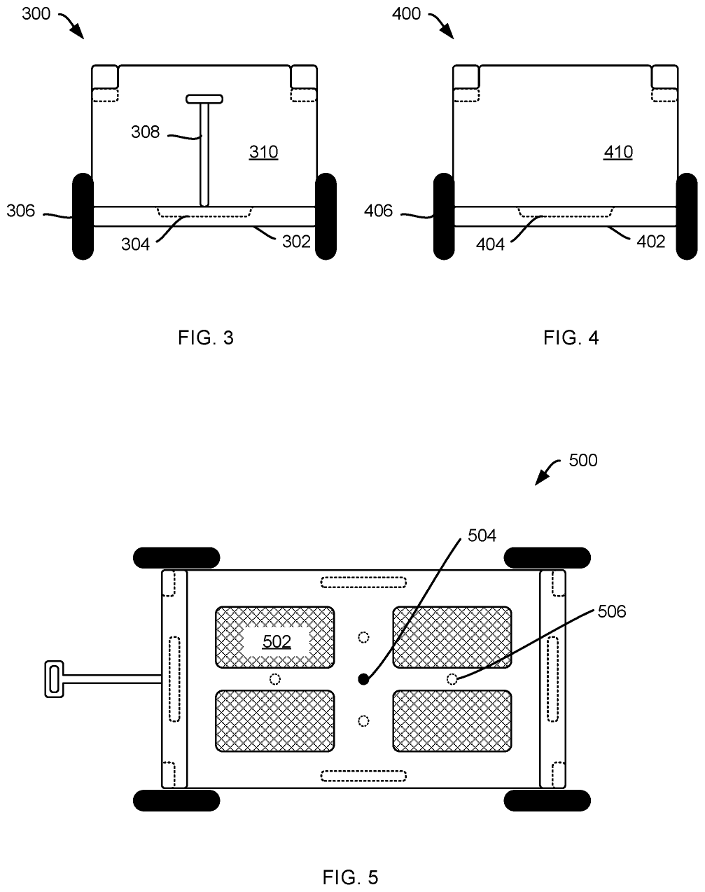

FIG. 1 is an illustrative sideview representation of an animal grooming wagon in accordance with embodiments of the present invention. In particular, FIG. 1 illustrates unwalled animal grooming wagon 100 and partially walled animal grooming wagon 110. It is noted that animals each have different levels of anxiety when grooming. While some animals are fairly docile, others may experience anxiety leading to disruptive behavior. Animal grooming wagon embodiments provide several levels of security for an animal to best accommodate an individual animal's needs. As such, animal grooming embodiments may be unwalled, partially walled, or fully walled. For docile animals, securing and transporting may be accomplished with an unwalled animal grooming wagon embodiment. In contrast, for other more anxious animals, securing and transporting may be accomplished with a partially or fully walled animal grooming wagon embodiment. As illustrated base 102 is initially unwalled. Base embodiments include a substantially planar top surface and form a substantially rectangular shape. Further illustrated are end walls 104A and 104B, which may be removably installed onto base 102 along opposite end portions of the base. Each end wall includes tab 106 located along the bottom edge of the end wall and sized to engage end wall receiving slots (shown in FIGS. 3 and 4) located along opposite end portions of the base. In embodiments, end walls are interchangeable and may be installed on either end of the base. When end walls 104A and 104B are installed onto base 102, a partially walled animal grooming wagon 110 results. It should be noted that end walls may be installed and removed with or without an animal being secured to the base. Still further illustrated is upper side wall receiving slot 108 for receiving an upper side wall tab. Upper side walls will be discussed in further detail below for FIG. 2.

FIG. 2 is an illustrative sideview representation of an animal grooming wagon in accordance with embodiments of the present invention. In particular, FIG. 2 illustrates partially walled animal grooming wagon 200 and fully walled animal grooming wagon 210. As noted above, animals each have different levels of anxiety when grooming. While some animals are fairly docile, others may experience anxiety leading to disruptive behavior. Animal grooming wagon embodiments provide several levels of security for an animal to best accommodate an individual animal's needs. As such, animal grooming embodiments may be unwalled, partially walled, or fully walled. For docile animals, securing and transporting may be accomplished with an unwalled animal grooming wagon embodiment. In contrast, for other more anxious animals, securing and transporting may be accomplished with a partially or fully walled animal grooming wagon embodiment. As illustrated base 202 is partially walled with end walls 208A and 208B. Further illustrated is side wall 218, which may be removably installed onto base along opposite side portions of the base. In embodiments, side walls are interchangeable and may be installed on either side of the base. Each side wall includes upper side wall tab 216 located along the top edge of the side wall and sized to engaged upper side wall receiving slot 206 located along a top edge of the end wall. Each side wall further includes tab 214 located along the bottom edge of the side wall and sized to engage side wall receiving slot 204 located along opposite side portions of the base. In some embodiments, handles 212 may be formed along an upper portion of the sidewall. When side walls 218 are installed onto base 202, a fully walled animal grooming wagon 210 results. It should be noted that side walls may be installed and removed with or without an animal being secured to the base.

FIG. 3 is an illustrative front-view representation of an animal grooming wagon 300 in accordance with embodiments of the present invention. As illustrated, base 302 is removably coupled with end wall 310. In this illustration, end wall 310 is positioned along the front edge of the base. As noted above, end wall 310 includes tab located along the bottom edge of the end wall and sized to engage end wall receiving slot 304 positioned along the front edge of the base. Front-view further illustrates steering bar 308 which is utilized for steering front steerable wheeled axle 306 that is positioned along the front-end portion of the base. In some embodiments, a braking mechanism may be utilized using any braking mechanism known in the art. Further, in some embodiments, the braking mechanism is actuated by the front steering bar so that when the steering bar is released, the braking mechanism is engaged, and when the front steering bar is elevated, the braking mechanism is released. In other embodiments the braking mechanism may be a cable actuated braking mechanism. In embodiments, the braking mechanism may be engaged on either the front steerable axle or the rear wheeled axle. A braking mechanism may provide additional safety when securing, transporting, and grooming an animal.

FIG. 4 is an illustrative rear-view representation of an animal grooming wagon 400 in accordance with embodiments of the present invention. As illustrated, base 402 is removably coupled with end wall 410. In this illustration, end wall 410 is positioned along the front edge of the base. As noted above, end wall 410 that includes tab located along the bottom edge of the end wall and sized to engage end wall receiving slot 404 positioned along the rear edge of the base. Rear-view further illustrates rear wheeled axle 406 that is positioned along the rear-end portion of the base. In some embodiments, a braking mechanism may be utilized using any braking mechanism known in the art. Further, in some embodiments, the braking mechanism is actuated by the front steering bar so that when the steering bar is released, the braking mechanism is engaged, and when the front steering bar is elevated, the braking mechanism is released. In other embodiments the braking mechanism may be a cable actuated braking mechanism. In embodiments, the braking mechanism may be engaged on either the front steerable axle or the rear wheeled axle. A braking mechanism may provide additional safety when securing, transporting, and grooming an animal.

FIG. 5 is an illustrative top-view representation of an animal grooming wagon 500 in accordance with embodiments of the present invention. In particular, FIG. 5 illustrates partially walled animal grooming wagon 500. As illustrated, animal grooming wagon 500 includes removable inserts 502 positioned along a top surface of the base. In some embodiments, the removable inserts are drain grates having a slot width of less than approximately 0.5 inches. As may be appreciated, grooming may include bathing an animal. In order to provide adequate drainage, removable inserts may be utilized. Removable inserts are easy to clean and replace. Where drainage is not required, removable inserts may include a solid flat surface. In other embodiments, inserts may be padded to provide a more comfortable resting surface for the animal. In still other embodiments, inserts may include a textured surface for better traction. As such, any type of insert may be utilized to accommodate a particular animal without limitation and without departing from embodiments provided herein. Further illustrated is anchor point 504 positioned centrally along the top surface of the base. A centrally located anchor point is useful to keep an animal from misstep on an edge of the base. In some embodiments, other anchor points 506 may be utilized to accommodate animals of various sizes. In some embodiments, the anchor point further comprises an adjustable anchor strap.

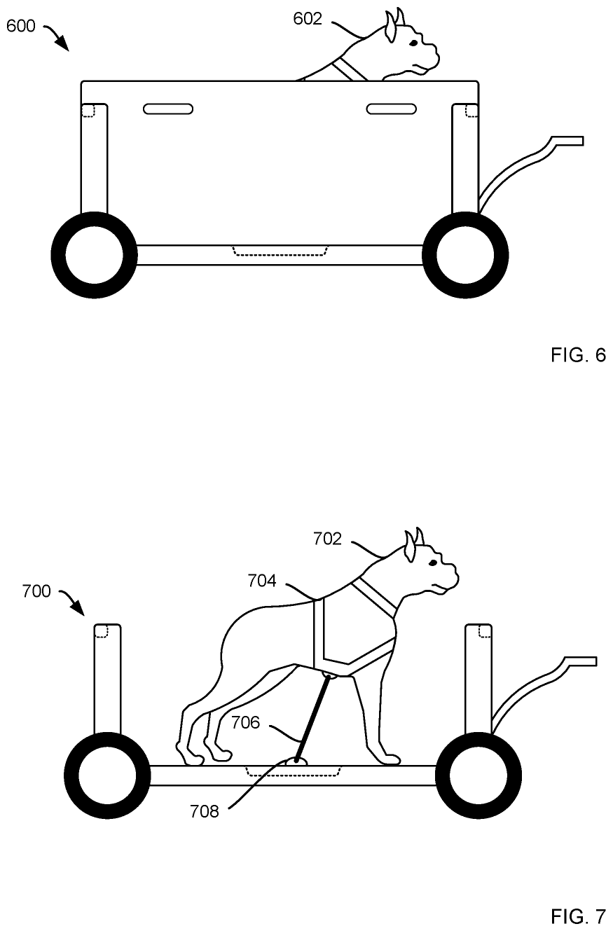

FIG. 6 is an illustrative sideview representation of animal grooming wagon 600 in use in accordance with embodiments of the present invention. In particular, FIG. 6 illustrates fully walled animal grooming wagon 600 with animal 602 secured and ready for transport or grooming. It may be appreciated that various animals of various sizes may benefit from embodiments provided herein. In some cases, an animal may become frightened or spooked when being transported on an open platform. The removable walls of animal grooming wagon embodiments provide physical as well as psychological security for an animal so that the animal may arrive relaxed and calm.

FIG. 7 is an illustrative sideview representation of animal grooming wagon 700 in use in accordance with embodiments of the present invention. In particular, FIG. 7 illustrates partially walled animal grooming wagon 700 with animal 702 secured and ready for transport or grooming. It may be appreciated that various animals of various sizes may benefit from embodiments provided herein. To secure an animal, an appropriately sized adjustable animal harness 704 may be utilized. In addition, adjustable anchor strap 706 may be secured with anchor point 708 to secure the animal and accommodate differently sized animals. In some cases, an animal may become frightened or spooked when being transported on an open platform. In a partially walled embodiment, the removable walls of animal grooming wagon embodiments provide physical security as well as psychological security for an animal so that the animal may arrive relaxed and calm.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

While this invention has been described in terms of several embodiments, there are alterations, permutations, and equivalents, which fall within the scope of this invention. It should also be noted that there are many alternative ways of implementing the methods and apparatuses of the present invention. Furthermore, unless explicitly stated, any method embodiments described herein are not constrained to a particular order or sequence. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. An animal grooming wagon comprising:
a base having a substantially planar top surface and forming a rectangular shape, wherein the base comprises:
a pair of end wall receiving slots each positioned along opposite end portions of the base;
a pair of side wall receiving slots each positioned along opposite side portions of the base;
a plurality of removable inserts positioned along the top surface of the base;
a front steerable wheeled axle positioned along the front-end portion of the base;
a rear wheeled axle positioned along the rear-end portion of the base;
a steering bar for steering the front steerable wheeled axle; and
an anchor point positioned centrally along the top surface of the base;
a first removable end wall having a first tab along a first bottom edge and sized to either of the pair of end wall receiving slots;
a second removable end wall having a second tab along a second bottom edge and sized to either of the pair of end wall receiving slots;
a first removable side wall having a third tab along a third bottom edge and sized to either of the pair of side wall receiving slots; and
a second removable side wall having a third tab along a third bottom edge and sized to either of the pair of side wall receiving slots.

2. The animal grooming wagon of claim 1, wherein the steerable front wheeled axle further comprises:
a braking mechanism.

3. The animal grooming wagon of claim 2, wherein the braking mechanism is actuated by the steering bar, wherein when the steering bar is released, the braking mechanism is engaged, and wherein when the steering bar is elevated, the braking mechanism is released.

4. The animal grooming wagon of claim 1, wherein the rear steerable wheeled axle further comprises:
a cable actuated braking mechanism.

5. The animal grooming wagon of claim 1, wherein the plurality of removable inserts comprises drain grates having a slot width of less than approximately 0.5 inches.

6. The animal grooming wagon of claim 1, wherein the anchor point further comprises an adjustable anchor strap.

7. An animal grooming system comprising:
an animal grooming wagon comprising:
a base having a substantially planar top surface and forming a rectangular shape, wherein the base comprises:
a pair of end wall receiving slots each positioned along opposite end portions of the base;
a pair of side wall receiving slots each positioned along opposite side portions of the base;
a plurality of removable inserts positioned along the top surface of the base;
a steerable front wheeled axle positioned along the front-end portion of the base;
a rear wheeled axle positioned along the rear-end portion of the base;
a steering bar for steering the front steerable wheeled axle; and
an anchor point positioned centrally along the top surface of the base;
a first removable end wall having a first tab along a first bottom edge and sized to either of the pair of end wall receiving slots;
a second removable end wall having a second tab along a second bottom edge and sized to either of the pair of end wall receiving slots;
a first removable side wall having a third tab along a third bottom edge and sized to either of the pair of side wall receiving slots; and
a second removable side wall having a third tab along a third bottom edge and sized to either of the pair of side wall receiving slots;
an adjustable anchor strap; and
an adjustable animal harness.

8. The animal grooming wagon of claim 7, wherein the steerable front wheeled axle further comprises:
a braking mechanism.

9. The animal grooming wagon of claim 8, wherein the braking mechanism is actuated by the steering bar, wherein when the steering bar is released, the braking mechanism is engaged, and wherein when the steering bar is elevated, the braking mechanism is released.

10. The animal grooming wagon of claim 7, wherein the rear steerable wheeled axle further comprises:
a cable actuated braking mechanism.

11. The animal grooming wagon of claim 7, wherein the plurality of removable inserts comprises drain grates having a slot width of less than approximately 0.5 inches.
